(19) United States
(12) Patent Application Publication
(10) Pub. No.: US 2003/0030664 A1
(43) Pub. Date: Feb. 13, 2003

(54) Customizable control panel software

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/928,577

(22) Filed: Aug. 13, 2001

(51) Int. Cl. G09G 5/00

(52) U.S. Cl. 345/744

(57) ABSTRACT

The present invention relates to customizable control panel software which enables a computer user to access, manage and update peripheral devices and software, obtain information, and interact with the World Wide Web (“Web”). In a preferred embodiment, the present invention provides methods and means for remotely accessing, managing, utilizing, and administering peripheral devices, such as printing devices. A system and methods for customizing a printer control panel are provided.

### FIELD OF THE INVENTION

The present invention relates to customizable control panel software which enables a computer user to access, manage and operate peripheral devices and software, obtain information, and interact with the World Wide Web (“Web”). The present invention provides methods and means for managing, utilizing, and administering peripheral devices, such as printers.

### BACKGROUND OF THE INVENTION

Computer users typically have one or more peripheral devices available to their computer either directly or via network. In either case, it is often desirable to change peripheral settings, obtain printer/printing information, manage or administer peripheral activity, and update peripheral drivers and files. For instance, a user may want to interrogate the print queue, determine printer status, change printer settings, or update printer files to better utilize the peripheral.

Considering a non-networked computer, a computer user typically has control of a peripheral, such as a printer, through control panel application software. Conventional printer control panel software, commonly referred to as “printer drivers,”=typically permit a user to configure the printer's working settings, change communication port settings associated with the printer, print test pages, change print drivers, and the like. These functions are typically configured via user “push button” selection of displayed software “tabs” on a graphical user interface presented to the user, the software tabs being assigned to different functional areas of the peripheral's capabilities. Although users are permitted to modify the printer's settings in the manner described, users are not normally able to modify the displayed software “tabs” or the areas of functional control provided by the control panel software.

Furthermore, control panel software for networked and non-networked peripherals usually has a fixed number of functions and/or options, which may not represent the full capabilities of the particular peripheral. In this regard, the peripheral software drivers and/or the computer's operating system may be limiting in terms of full functionality support.

Additionally, each make and model of a peripheral is usually supported by its own unique driver software. Therefore, if a user intends to interrogate several peripheral printers, each one is typically presented separately via a different control panel screen and driver software. Of course, operating systems are commonly equipped to “multi-task”, thus allowing multiple printer settings and printer queues to be viewed simultaneously. The drawback to these typical configurations, however, is that several open windows may crowd the computer screen and take up system resources (e.g., RAM). Furthermore, each driver application must be executed and terminated individually.

As a further consideration in the operation of a peripheral, a computer user desiring to update or obtain printer driver software must typically manually download and save each driver file into permanent memory of the workstation. Normally, such downloading is time intensive as the driver software is typically obtained from an Internet site through a local web browser. Additionally, the vast majority of peripheral control panel applications do not offer functionality for updating the peripheral drivers.

Peripheral control panels of networked systems essentially provide the same functionality as peripheral control panels of non-networked systems, but must interact with the additional software and hardware architecture found in a network system. A network printer, for example, can print only one job at a time yet must be available at all time to multiple users. For this reason, a print server, also known as a print spooler, is typically attached to each printer as a network interface. When a print job is sent to the network, the network OS routes the print job to the print server. Upon receiving data destined for one or more printers, the print spooler writes this data into a temporary file instead of sending it immediately to a printer. For example, when a single user or multiple users initiate commands on workstation(s) to print a number of documents, the print spooler queues the documents by placing them in an interim holding area called a print buffer or print queue. The printer then pulls the documents off the queue one at a time. Later, when the printer becomes available, the print spooler will write the data to the printer, thus completing the network communication to the printer. Accordingly, in most network settings, the control panel of a networked user typically is the same as that as for a non-networked user, except that the “path” for the print data differs

The order in which a print spooler executes jobs on a queue depends on the priority system being used. Most commonly, jobs are executed in the same order that they were received on the queue (i.e., on a first in first out basis), but in certain jobs can be given higher priority dependent upon the particular system scheme. Typically, a particular print job will remain on queue until printed, at which time incoming print jobs may be allowed to overwrite the print request. Spooling thus lets multiple users place a number of print jobs on a queue instead of waiting for each one to finish before specifying the next one. The operating systems of individual workstations are also often configured with print spoolers specific for the particular workstation.

Network operating systems also typically contain software applications for managing and administering peripherals. These applications may be executed via an administration application such as NWADMIN, where the network OS is NETWARE. Further, other network specific applications may be executed at a command line, such as NPRINT, or RCONSOLE. Alternatively, a Unix network OS or Microsoft network OS may be employed. Further, printer hardware and software may be accessed through printer specific protocols such as the Network Printing Alliance Protocol (NPAP) used by Lexmark International, Inc. of Greenwich, Conn., or the Simple Network Management Protocol (SMNP) used by Hewlett-Packard Co. of Boise, Id. Although many applications may interrogate a network print queue, print server, or printer, detailed information regarding the printer and print server is not often available to the typical user.

The difficulties of accessing and managing peripherals over a network have been recognized in the art. For instance, U.S. Pat. No. 5,537,626 to Kraslavsky et al. describes a circuit board coupled to a printer, which allows the printer to be utilized and controlled over the network. In addition, NEB-software is included which bundles and implements network OS printing modules and thereby the network OS printing services are available, inter alia, in one application. The Kraslavsky reference, however, does not disclose Internet functionality associated with the NEB-software, and further does not disclose peripheral software offering a customizable interface.

U.S. Pat. No. 5,647,056 to Barrett et al. discloses a network board and software, which allow information to be transmitted from a printer to a computer user, thus making the peripheral “an effective and intelligent member of the network.” Also, the Barrett reference allows a computer user to access “front panel” functions of a printer from a computer, thus increasing user control over a peripheral. The Barrett reference does not disclose Internet functionality associated with the control software, and does not disclose customizable software interfaces.

U.S. Pat. No. 6,148,346 to Hanson (“Hanson”) discloses a data communication system for allowing communications between various devices and various operating systems across a network. In particular, Hanson discloses software with a Graphical User Interface (“GUI”) employing Java™ computer language to provide a “dynamic” (two-way communication) link to peripheral devices. The device driver of Hanson includes two components: an operating system specific device driver portion and operating system independent device driver portion. The operating system specific device driver portion provides a two-way translation communication layer between the host operating system and the operating system independent device driver portion. The operating system independent device driver portion includes object-oriented code with the device driver information required for operation of the device.

In Hanson, the host computer system assigns each peripheral device a unique address, and then retrieves the operating system independent driver, which is remotely or locally stored. The host computer then interprets the retrieved peripheral device driver through the operating system specific device driver portion. The host computer thus controls the peripheral device according to user-initiated commands provided to the peripheral through the translation layer provided by object-oriented programming.

The Hanson reference, however, uses network access and control of a peripheral, rather than Internet access to and control of a peripheral, using the device driver software specified therein. Also, the Hanson reference fails to disclose a customizable GUI.

As a further shortcoming common to the prior art, typical interactions between a user and a network system peripheral generally preclude access to a great deal of information for the user. A control panel application typically tells very little about the network print jobs other than the file sent and the owner. For example, a user cannot usually access information about priority of the queued jobs, the status of the print server, or other information about the network system or peripheral. Customizable control panel software would allow for users to quickly determine the important information concerning computer peripherals available to their computer. For instance, often multiple printers are available to a computer, and by displaying the activity of each peripheral a user could choose an available peripheral.

Therefore, what is needed in the art are customized or customizable control panels that allow users and/or network managers maximum flexibility and functionality in the management of peripheral devices. Improved peripheral application functionality would greatly enhance access, control, management, and utilization of computer peripherals, including printing devices, while customizable control panel screens would allow the user or manager to organize control panel functions such that the control panel is optimized for that user or manager. Moreover, it would be advantageous for the access, control and management functions to be available over the Internet, thus allowing for convenient and remote access of a peripheral by web-based devices.

### BRIEF SUMMARY OF THE INVENTION

The present invention provides customizable control panel software and methods of using the software to access, control, and manage peripheral devices, such as printing devices. Generally, the methods of the present invention comprise using a printing device incorporating a web server linked to a network, initiating a remote request over the network for a web page from the web server by a web browser, the web page associated with at least one software application configured to provide customizable control panel functionality for controlling operations of said printing device, transmitting the web page over the network, downloading and displaying the web page using the web browser, downloading the at least one software application using the web browser in response to downloading the web page, and customizing a printer control panel using the at least one software application.

In a preferred embodiment, customizable control panel software is provided to a manager, network administrator or other user through a displayed web page of a printing device, allowing the user to create one or more customizable control panels having user-specified functionality for the device thereon. Further preferably, the customizable control panel software of the present invention provides a library of selectable features comprising functionality for the complete array of operations for the printing device. In a related embodiment, the customizable control panel software of the present invention comprises one or more multi-threaded Java applets, which run on a Java Virtual Machine platform residing on the user's workstation.

To create a customized control panel according to an embodiment of the present invention, a user on a networked workstation may enter a URL for a Web server, which has been associated with a peripheral device. The user then surfs to a Web page posted by the web server which provides menu options for selecting desired functionalities of one or more control panels for accessing, controlling, and/or managing the peripheral device. Preferably, the menu will display selectable control features typically associated with conventional device driver software for operation of the device, and additionally display selectable control features offering enhanced functionalities not typically associated with conventional device driver software. From the Web page, the user selects the desired functionalities from the menu, and may arrange and organize the selected functionalities in a user-determined configuration. The selected functionalities and configuration may then be stored in a specified directory of the peripheral, the user's workstation, or an intermediary device for later use in accessing, controlling, and/or managing the peripheral device.

In one aspect of the embodiment, a user is initially provided with a default template as a preset graphical user interface, which may be customized. In a second aspect of the embodiment, the user may add text and controls to the options provided on the menu. In a third aspect of the embodiment, the user may use the customized control panel to introduce and/or configure displayable advertising banners and/or plugins on a Web page broadcast from the device.

A system for customizing a printer control panel is also provided. The system comprises a printing device incorporating a web server linked to a network, at least one workstation configured for communicating with the network, the at least one workstation having a web browser thereon; and at least one software application transmissible by the server and accessible by the web browser, the at least one software application configured to provide customizable control panel functionality for the printing device through user input on the at least one workstation.

### BRIEF DESCRIPTION OF THE SEVERAL VIEWS OF THE DRAWINGS

In the drawings, which illustrate the present invention:

FIG. 1 illustrates apparatus and a simplified operating environment for use in the present invention;

FIG. 2 is a block diagram of exemplary network architecture for use in the present invention;

FIG. 3 shows a generic embodiment of a customized or customizable printer control panel according to the principles of the present invention;

FIG. 4 is illustrative of a first exemplary control panel for use in the methods of the present invention; and

FIG. 5 is illustrative of a second exemplary control panel for use in the methods of the present invention.

### DETAILED DESCRIPTION OF THE PREFERRED EMBODIMENTS

The present invention provides customizable control panel software, which enables a computer user to access, manage, control printing devices and related software. A user may configure one or more control panels related to a printing device to display and interact with printing device functions and information as deemed appropriate. In a preferred embodiment, the present invention makes use of a Java-enabled Web browser on a Web-based device, a java applet accessible by the Web browser, and an embedded Web server incorporated in a printing device, to carry out the methods described herein. The control panel software may also recognize and communicate with different network applications and network protocols, print servers and print server protocols, as well as printing device software and printing device specific protocols.

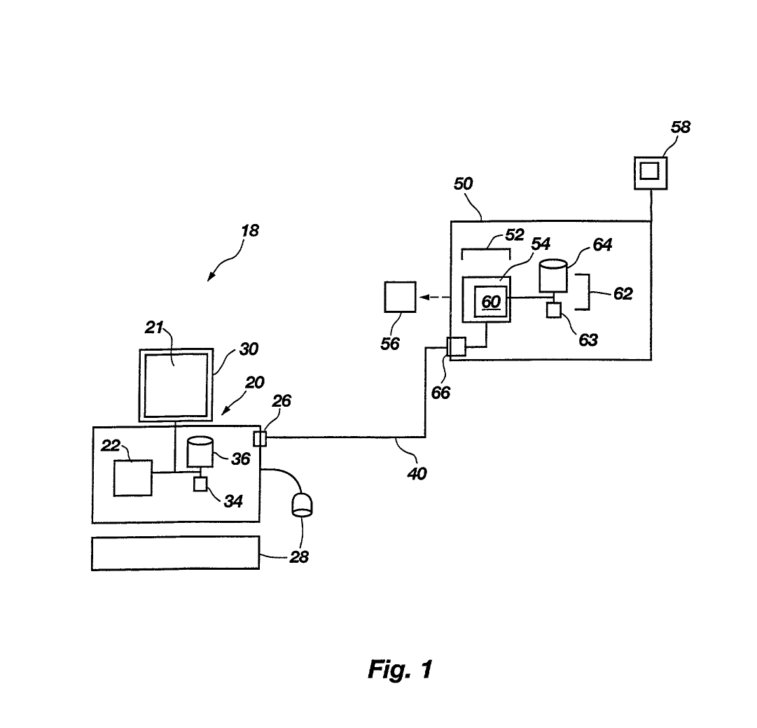

Referring to drawing FIG. 1, a simplified operating environment 18 for an embodiment of the present invention is illustrated. The operating environment 18 comprises one or more workstations 20 networked with a printing device 50, where the printing device 50 is configured with an embedded web interfacing system 52. Workstation 20 is shown bi-directionally connected to printing device 50 through conventional communication links 40, which may include, for example, one or more of an Internet connection, a wireless connection, local area network (LAN) (e.g., ethernet, token ring, etc.), wide area network (WAN), bus line, Fiber Channel, ATM, or a direct connection using a parallel or serial cable. Other components (not shown), such as fax machines, scanners, servers, and other printing devices are also typically provided in operating environment 18 and connected with communication links 40. Communication links 40 logically link the various physical components of operating environment system 18 together, regardless of their physical proximity to one another.

Workstation 20 will preferably be conventionally configured, and thus typically comprise at least one high speed processing unit (microprocessor) 22, in conjunction with a memory system 24, a network interface (not shown), input devices 28, and a display monitor 30. These elements within workstation 20 are interconnected by at least one bus structure (not shown).

Input devices 28 of workstation 20 are typically computer-input devices well known in the art. For example, input devices 28 may comprise a keyboard, a mouse, a trackball, a microphone, a scanner, and the like. Workstation 20 may also comprise further output devices known in the art, such as speakers, etc. Other devices, such as such as a modem, may be used as both an input device 28 and an output device.

The memory system 24 of workstation 20 generally includes high-speed main memory 34 in the form of random access memory (RAM) and read-only-memory (ROM). Memory system 24 generally also includes one or more secondary storage devices in the form of long term storage mediums such as hard disks 36, disk drives, tape drives, zip drives, CD-ROM, flash memory, etc., and other devices that store data using electrical, magnetic optical or other recording media. Those skilled in the art will recognize that the memory system 24 may comprise a variety of alternative components having an assortment of storage capacities.

As is familiar to one skilled in the art, workstation 20 further includes an operating system and at least one client application program. The operating system comprises software which controls the workstation 20, including allocation of its resources. The client application program comprises software that performs one or more tasks requested by the user via workstation resources made available through the operating system. The operating system and the at least one client application each reside within memory system 24. Preferably, the operating system employs a graphical user interface where the display output of an application program is presented as a “window” on the screen of the display monitor 30. Further preferably, the operating system for use in the present invention is configured for multi-tasking (allowing application programs associated with workstation 20 to execute computing tasks in multiple threads). Exemplary multi-tasking operating systems include versions of Microsoft's Windows™ or Windows NT™ operating systems, IBM's OS/2 Warp operating system, Apple's Macintosh OS versions 8 and 9, X-Windows, and the like.

The at least one client application software of workstation 20 includes a graphical user interface software application used to locate and display Web pages, commonly called a Web browser 21. Web browser 21 is preferably stored on the hard disk 36 of workstation 20. Most preferably, the Web browser 21 for use in the present invention is a standard Java-enabled Web browser, such Sun Microsystems' HotJava®, Netscape's Navigator® or Microsoft's Internet Explorer®.

In an embodiment of the present invention, workstation 20 also includes software comprising a Java Virtual Machine platform, which may be embedded in software associated with Web browser 21 or which may be separately installed in permanent memory of workstation 20. The Java Virtual Machine enables workstation 20 to execute programs written in the Java™ computer language (“Java”), and advantageously serves as consistent platform across different kinds of computers and operating systems, thus allowing the same Java application to run within browsers on PC, Macintosh, and UNIX workstations, etc. The Java Virtual Machine platform translates the Java-based applets and applications to bytecodes, which are understood by the underlying operating system of workstation 20.

Still referring to drawing FIG. 1, a preferred printing device 50 for use in the present invention is configured with both printer specific hardware and software and an embedded Web interfacing system 52 for enabling access and interaction with other devices linked to local and external communication networks (“networks”), including the World Wide Web, a local area network, an intranet, the computer network of an on-line service, etc. Printer specific hardware and software of printing device 50 may be provided in any conventional printer configuration known in the art, including those associated with laser printers, impact printers, photographic printers, and inkjet printers. Printing device 50 includes one or more local displays 58, which may comprise a conventional monitor, a monitor coupled with an integrated display, an integrated display (e.g., LCD), or other means for viewing print queues, downloaded web pages, and associated data or processing information, including printer specific information. Printing device 50 also includes a network interface (I/O) 66, which may comprise a network interface card (“NIC”), for communication with one or more and preferably all of the various networks (LAN, WAN, Internet, etc.) through communication paths or links known in the art, including wireless connections, ethernet, bus line, Fiber Channel, ATM, standard serial connections, and the like.

In an embodiment of the invention, the embedded Web interfacing system 52 comprises an embedded Web server 54 providing Web server functions to requesting users linked to one or more of the various networks (LAN, WAN, Internet, etc.) supporting printing device 50. The preferred printing device 50 of the present invention may thus be the same or conceptually similar to the printer apparatus configured with an embedded Web server described in U.S. Pat. No. 5,956,487 to Venkatraman et al., assigned to the assignee of the present invention, the disclosure of which is hereby incorporated by reference herein in its entirety.

Still referring to drawing FIG. 1, the embedded Web server 54 of the present invention is preferably housed in printing device 50 on a single microprocessor board (not shown), which includes a microprocessor 60 responsible for controlling all aspects of embedded Web server 54, and wherein communication protocols and executable programs relating to the Web and the display of Web pages are stored in ROM. Microprocessor 60 is preferably part of the existing circuitry associated with a conventional printer. As such, microprocessor 60 is preferably configured to perform some or all of the printer specific functions of printing device 50, including control of printer specific hardware and software. Microprocessor 60 is also provided with memory 62 in the form of RAM 63 and/or hard disk memory 64, which may be associated with a print cache memory of printing device 50, or which may be provided separately from the print cache memory. In one embodiment, a percentage of memory 62 in printing device 50 may be dedicated to embedded Web server 54. Alternatively, embedded Web server 54 may share the available memory 62 in printing device 50 with the print cache memory. Typically, printing device 50 will be equipped with a minimum of 64 megabytes of RAM 63, although less RAM 63 may be used in certain configurations.

Printing device 50 also will preferably contain executable software programs stored on a hard disk 64 for operation of Web server 54. Hard disk 64 may also contain printer specific software programs relating to the operation of printer specific hardware. Alternatively, a separate hard disk (not shown) may optionally be provided with the requisite software programs for printing. In an embodiment of the invention, embedded Web server 54 uses microprocessor 60 and the ROM-stored protocols to exchange data with other devices/users on one or more of the networks via Hyper Text Transfer Protocol (HTTP) and Simple Mail Transfer Protocol (SMTP), although other protocols such as File Transfer Protocol (FTP), Simple Network Management Protocol (SNMP), and Gopher document protocol may also be supported. Embedded Web server 54 is further configured to send and receive HTML formatted files.

Using microprocessor 60, associated software, and internal circuitry of printing device 50, embedded Web server 54 supports one or more control operations that relate the functions of printing device 50. Preferably, embedded Web server 54 is configured to support the complete set of printing operations of printing device 50, including operation of the printing device cache memory 62.

In addition to being linked to a LAN and/or WAN, printing device 50 is preferably linked directly to the Internet via network interface 66 and communication links 40 attached thereto. Embedded Web server 54 within printing device 50 is provided with at least one Uniform Resource Locator (URL), by which it is identified on a network, and which can be accessed via HTTP, for example, from a remotely located workstation over a LAN, WAN, or over the Internet. Embedded Web server 54 may also be accessed by other Web-based devices (not shown) in a peer-to-peer relationship.

Embedded Web server 54 preferably generates at least one web page (e.g., an HTML page with CGI scripts) 56 that provides an interface for printing device 50 that can be accessed by a workstation 20 or an Internet-based device via a browser client with the appropriate URL address. Since embedded Web server 54 supports SMTP protocol, embedded Web server 54 can also be accessed via an e-mail client. As previously discussed, embedded Web server 54 is preferably configured to support the complete set of printing operations of printing device 50, to include: decoding transmitted information to be printed, storing print jobs in print cache memory 63, printing from print cache memory 63, and querying the status of print jobs stored or previously stored in cache memory 63.

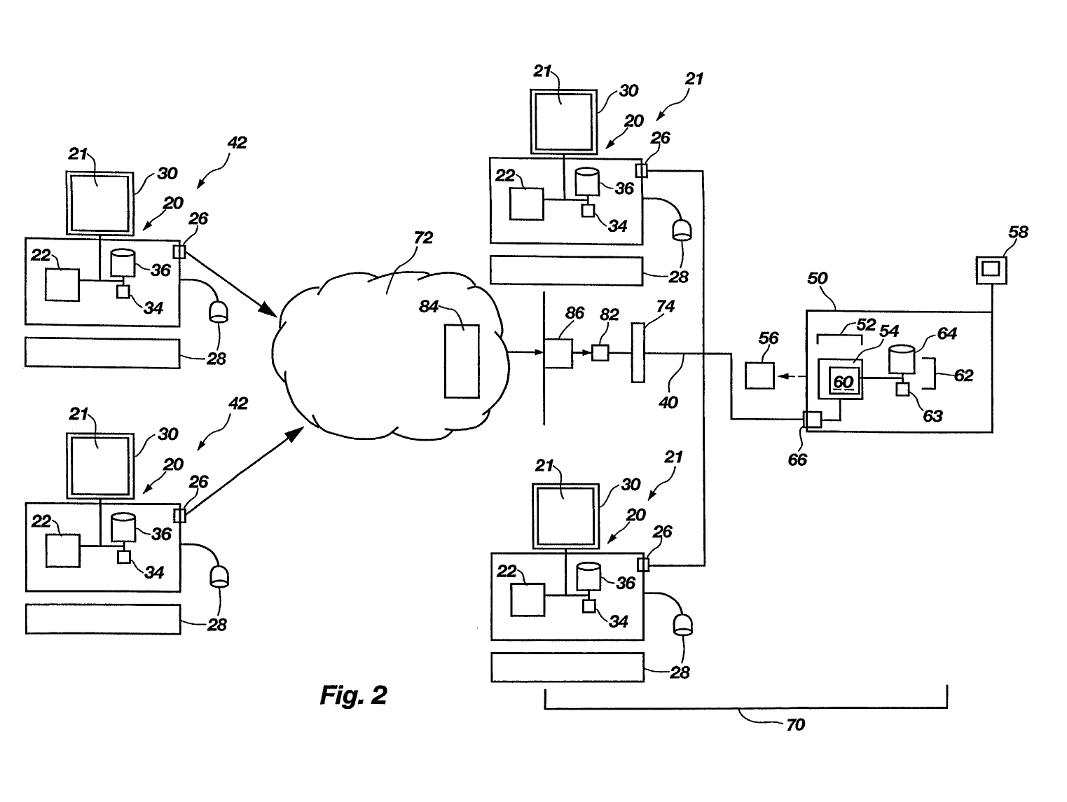

Referring now to drawing FIG. 2, workstations 20 and printing device 50 are illustrated in an exemplary local network architecture 70. Residing outside of local network architecture 78 are remote workstations 42. The same or similar components on remote workstations 42 are referenced by the same reference numerals shown on workstations 20. Remote workstations 42 are remotely located from, but connectable to, local network architecture 70 through the Internet 72. Thus, remote workstations 42 have Internet access through conventional communication links 44, which may include DSL, various network-to-ISP type connections, (e.g., T-1), dial-up connections, and the like, as well as various intermediary devices and links (not shown) known in the art, such as servers, LANs, routers, and the like.

Within local network architecture 70, workstations 20 are bi-directionally connected to a LAN server 74 by a network communication link 40. Typically, LAN server 74 is configured for managing network resources within local network architecture 70. LAN server 74 is, in turn, connected to a router 82, which provides access to the Internet 72, by routing data (e.g., IP-Packets) generated by workstation 20 through an HTTP server 84. Router 82 further functions to distribute incoming data from Internet 72 which is intended for workstations 20, printing device 50, or other Web-based devices linked within the local network architecture 70.

Local network architecture 70 also includes a gateway 86, which will typically comprise a software and/or hardware firewall. Gateway 86 functions to block various external data transmissions from being sent to locations residing inside local network architecture 70. In this regard, gateway 86 is restrictively configured to allow remotely situated users to access web pages within local network architecture 70 (e.g., via HTTP protocols), and to block all other access. Gateway 86 also provides a port for outgoing Internet traffic. Gateway 86 is further preferably configured to internally route IP-Packets sent from workstations 20 to other web-based devices (e.g., printing device 50) also residing within local network architecture 70, and vice versa.

According to the principles of the present invention, customized or customizable control panels can be accessed, created and/or reconfigured through interaction of a workstation 20 or a remote workstation 42 with the Web interfacing system 52 of printing device 50. To connect with embedded Web server 54 of Web interfacing system 52, a user activates a Web browser 21 on a workstation 20 or a remote workstation 42, and then enters a network address (e.g., a Uniform Resource Locator (URL)) associated with embedded Web server 54. The URL address may be supplied by the user in variety of ways, to include direct keyboard entry of the address, selection of a previously stored “bookmarked” address, or “clicking” on an appropriate hyper-text link appearing on a Web browser control bar or on a displayed Web page. The URL identifies both the Internet or intranet location of Web server 54 and one or more pages of information and/or data contained at that site.

Using the URL, Web browser 21 sends a command in the form of a retrieval request (a “fetch command”) to embedded Web server 54, as identified in the URL address. For remote workstations 42, the fetch command is forwarded over Internet 72, through gateway 86 and to router 82, where the command is then distributed to embedded Web server 54. When the fetch command is initiated by a workstation 20 within local network architecture 70, gateway 86 has preferably been configured with command lines, which recognize the internal address of embedded Web server 54 so as to route the command to embedded Web server 54 directly, and without the fetch command leaving local network architecture 70. Alternatively, a fetch command may be sent directly to embedded Web server 54 by specifying an intranet address as the URL if local network architecture 70 is configured as an intranet. In another aspect of the embodiment, commands sent from workstation 20 are first sent to an ISP supporting Internet access by workstations 20, and then routed back to local network architecture 70 for delivery to embedded Web server 54 by the ISP.

In response, embedded Web server 54 generates at least one Web page 56 that provides an interface for workstations 20 and remote workstations 42 for accessing, creating, and/or configuring one or more customized or customizable control panels according to the present invention. Preferably, and for obvious reasons of security, the contents of Web page 56 will not be accessible by unauthorized users. In this regard, access to Web page 56 may be authorized by entry of a PIN and/or password provided to authorized users.

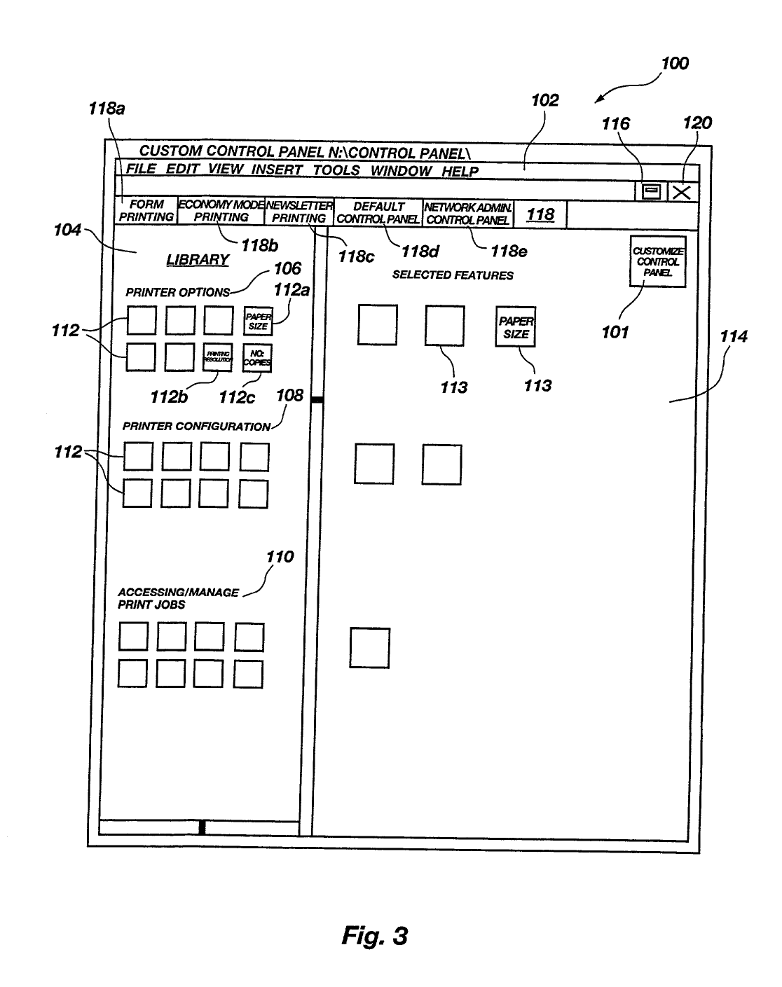

A generic embodiment of a customized or customizable printer control panel 100 is illustrated in drawing FIG. 3. Customized or customizable printer control panels 100 are user-specific or network-specific configuration files preferably displayed as a control panel graphical user interface (GUI) 102. By “user-specific configuration files” it is meant herein that the configured files are adaptable or adapted to the needs of a single individual, or a group of individuals, such as a particular workgroup within an office setting. The control panel GUI 102 will typically be independently operable from, but linked for certain functions to, Web browser 21 and other software applications of workstation 20 or remote workstation 42. Initially, customized or customizable printer control panel 100 may be configured as a default or template control panel that provides one or more preselected features that can be added to, or deleted from, control panel GUI 102. Alternatively, control panel GUI 102 may be initially provided as a blank control panel GUI awaiting selection of one or more features by a user.

In accordance with the principles of the present invention, customized or customizable printer control panels 100 may be configured to be threaded with various software applications (e.g., word processing software applications) such that customized or customizable printer control panels 100 are “triggered” upon a user-initiated “print command” from within the various software applications. In this embodiment, a Web browser 21 of workstation 20 or remote workstation 42 may be configured to automatically initiate a request to embedded Web server 54 of printing device 50 to send a displayable Web page 56 to Web browser 21, which includes one or more customized, or customizable printer control panels 100 thereon. The features on the called-up customized or customizable printer control panel 100 may then adjusted by the user by way of on/off selectors, “OK” buttons, and the like, or the pre-selected features may be accepted for printing as a whole by, for example, the simple selection of a “Print” button 103 on the control panel GUI 102.

In a second related embodiment of the invention, a print command from a software application (e.g., a word processing software application) causes a predetermined customized or customizable printer control panel 100 to be sent from embedded Web server 54 to Web browser 21, whereupon the customized or customizable printer control panel 100 then automatically initiates the selected printing features as previously configured thereon. In this manner, customized or customizable printer control panels 100 are triggered in lieu of a print driver component of a workstation 20 or a remote workstation 42.

In a third related embodiment of the invention, a customized or customizable printer control panel 100 which was initially configured via interaction between an embedded Web server 54 and a workstation 20 or a remote workstation 42 (as described in detail below) is stored in memory 24 of a workstation 20 or a remote workstation 42. In this embodiment, the customized or customizable printer control panel 100 is preferably stored as a control panel GUI 102 which operates independently from Web browser 21 for most purposes (with the exception of further customization procedures as described below). A print command from within a software application, or the retrieval of the control panel GUI 102 file from a specified directory, causes the subject workstation (workstation 20 or remote workstation 42) to access the previously configured customized or customizable printer control panel 100, whereupon the selected features thereon can be automatically executed or manually controlled by, for example, pointing and clicking.

Customized or customizable printer control panels 100 may also be configured as stand-alone applications for accessing and managing the configuration of printing device 50. According to this embodiment, default settings for printing device 50 may be globally changed for use within the local network architecture 70 as a whole. Alternatively, a customized or customizable printer control panel 100 may be used to narrowly reconfigure the default settings of printing device 50 for only one or more specified users (e.g., the users within a particular workgroup). Thus, customized or customizable control panels 100 may be utilized by user at a workstation 20 or remote workstation 42 to “customize” the settings and configuration of printing device 50 such that all, or some, of the printing requests or other operational requests sent to printing device 50 will be carried out according to the customization. Again, the various feature options of customized or customizable printer control panels 100 may thus be exercised or exercisable in lieu of print driver components of workstation 20 or remote workstation 42.

To begin customization of a control panel GUI 102, a user at a workstation 20 or remote workstation 42 may, for example, click on, touch (using touch screen technology), or otherwise activate a “customize control panel” button 101 provided on control panel GUI 102. Upon activating the “customize control panel” button 101, a library window portion 104 of control panel graphical GUI 102 may “pop up,” or otherwise be presented, which is configured with a “library” of selectable features displayed thereon.

In accordance with the principles of the present invention, the library of selectable features allows authorized users to use forgo the control panels provided by conventional print driver software, and to designate, delete, or adjust the printing features of their choice for incorporation into one or more customized and/or customizable control panels 100. Thus, the present invention recognizes that many users may be burdened with the inflexibility of conventional print driver software, to include the number menu tabs or layers that must be selected through in order to chose the print features of their choice. In addition, the present invention provides methods and apparatus which enable the organization of print features into a number of customized control panels which may be advantageous in meeting the specific needs of office workgroups, individuals, or particular types of print jobs.

Preferably, the library of selectable features includes a complete array of features which can be used for the operation, management, and configuration of printing device 50, to include the operation, management, and configuration of embedded Web server 54. Thus, the library of selectable features includes, but is not limited to: 1) various options for printing documents on printing device 50 (such as paper handling options (e.g., collation, stapling, output destination, etc.), paper size, printing resolution (e.g., dots per inch), duplex printing, number of copies, selected pages to print, image orientation, postscript output options, fonts, color printing, etc.); 2) the operational configuration of printing device 50 (e.g., allocation and reallocation of memory resources, adjustment of printer speed and network settings, software options, power saver settings, diagnostics, paper handling options, paper size, power saver settings, printer default settings, etc.); 3) manipulation of the print queue and job retention directory of printing device 50, and the like.

Depending on the display capabilities of display monitor 30 and/or the number of available features in the library of selectable features for printing device 50, however, all of the available features may not be simultaneously displayable within window portion 102. In this regard, known techniques for viewing other available features, such as horizontal or vertical scrolling, are preferably employed to provide the maximum number of feature options for the user. Of course, other available library features could also be retrieved, for example, by the selection of menu options and buttons (not shown) labeled for such purpose.

The library of selectable features may be arranged on control panel GUI 102 by, for example, feature categories with related features grouped in various arrays. As further shown in FIG. 3, library window portion 104 displaying the library of selectable features has been subdivided into a “Printing Options array” 106, comprising the complete array of printing options for printing device 50, a “Printer Configuration array” 108, comprising the complete array of configuration options for printing device 50, and an “Access/Manage Print Jobs array” 110, comprising the complete array of options for accessing and managing the print queue and job retention directories of printing device 50.

Typically, each of the various functionalities under the array categories 106, 108, 110 will be represented by a labeled button, icon, and/or thumbnail of a labeled button or icon. In FIG. 3, the various functionalities are displayed as “labeled feature buttons” 112, which are thumbnail versions of the relatively larger “selected labeled feature buttons” 113, described hereinafter. For example, labeled feature buttons” 112a, 112b, and 112c are provided for the feature functionalities of paper size, printing resolution and number of copies, respectively. By selecting or deselecting one or more labeled feature buttons 112, a wide array of features can be easily be customized on control panel GUI 102 according to, for example, the printing options most used by a particular user or workgroup, or according to printing options most suited for a specific tasks or set of tasks (e.g., printing options for use with recurring printing jobs, such as the printing of various forms).

Selection of the print features from the library of selectable features may occur by a variety of means including, but not limited to, activation of on/off selectors (e.g., “checking” a box associated with a labeled feature button 112, “pressing” or “highlighting” a labeled feature button 112 to select or deselect a particular feature, “double-clicking” on a labeled feature button 112, etc.), selection of features and feature options from a drop-down menu or other menu type, and use of “click and drag” techniques.

In the embodiment of the invention shown in drawing FIG. 3, the selected features are compiled in a “selected feature window” 114 as “selected labeled feature buttons” 113 for incorporation into a user-configured and usable version of a customized or customizable printer control panel 100. As shown in drawing FIG. 3, labeled feature buttons 112 which have been selected from each array 106, 108, 110 are shown disposed adjacent each respected array 106, 108, 110 as selected labeled feature buttons 113. For example, three features are shown as selected from the Printer Options array 106, one of which was paper size as represented by labeled feature button 112a in library window portion 104. Two features are shown selected from the Printer Configuration array 108, and one feature has been selected from the Accessing/Managing Print Jobs array 110. Features (represented by selected labeled feature buttons 113) can be added or deleted from selected feature window 114 at any time by known techniques, including the activation, “pressing” or “highlighting, double-clicking and menu techniques described above.

Selected labeled feature buttons 113 may also be arranged in location (e.g., by clicking and dragging) and manipulated in a desired presentation style on control panel GUI 102. In this regard, selected labeled feature buttons 113 may be associated with a “properties” utility, using which varying button types, button sizes, button labeling, and the like may be effected thereby. In another aspect of the embodiment, options may be provided for varying the window size of selected feature window 114. Also, features that do not fit within a displayed area of selected feature window 114 may be added into areas of selected feature window 114 which are accessible by horizontal or vertical scrolling techniques known in the art.

Furthermore, the present invention contemplates an option wherein related features can be “layered” in a hierarchical and customized fashion. In this aspect of the embodiment, user selection of a first “layer” of a feature option is designed to call up one or more other layers of various other options, which can be selected from. A “feature layer” button 111 may be provided on control panel GUI 102 and configured for this utility.

Once all of the desired features are displayed in selected feature window 114 as selected labeled feature buttons 113, the customized or customizable printer control panel 100 can be saved and provided with a user-selected file name. Saving and naming actions may occur by, for example, by clicking on or otherwise activating a “save” button 116 displayed on control panel GUI 102. Activation of save button 116 displays a dialog box which requests the user to enter a file name and file directory for storing that particular assembly of features as a customized or customizable printer control panel 100. To end a session using a customized or customizable printer control panel 100, one or more “close” buttons 120 or other similar exiting techniques may be provided on control panel GUI 102. Additionally, users who have designed a particular customized or customizable printer control panel 100 may be provided with a utility configured to “lock” in selected features so that they may not be changed unless a user supplies the proper PIN and/or password.

In an aspect of an embodiment of the invention, one or more customizable printer control panels 100 are saved to a directory accessible by other workstations 20 on local network architecture 70, or even by users at remote workstations 42. In this regard, a directory for storage of customized or customizable printer control panels 100 may reside in a component of memory 62 on printing device 50, where the control panel files may be accessible by interfacing with embedded Web server 54 through links comprising local network architecture 70 and/or Internet 72. Alternatively, customized or customizable printer control panels 100 may be stored in a network-based storage device, such as a network file server (e.g., LAN server 74 of drawing FIG. 2), where the control panel files may be retrieved by users on devices with access to local network architecture 70 (e.g., users on workstations 20 or remotely situated users able to gain access to local network architecture 70 by, for example, use of a Citrix™ server).

Further alternatively, customized or customizable printer control panels 100 may be stored in memory system 24 of workstations 20 or remote workstations 42. When stored in memory system 24 of a workstation 20 or remote workstations 42, the customized or customizable printer control panels 100 will typically only be accessible by authorized users of those workstations. In a preferred aspect of the embodiment, customized or customizable printer control panels 100 stored in memory system 24 of a workstation 20 or a remote workstations 42 may be further customized by activation of the customize control panel button 101. In this case, the customize control panel button 101 is configured with an embedded link to embedded Web server 54 which, when selected, activates Web browser 21 to request embedded Web server 54 to send control panel configuration data in the form of a software application configured to provide printer control panel functionality for printing device 50. Typically, the software application will comprise the selectable features library and all or some of the configuration options used to configure the customized or customizable printer control panels 100. Web browser 21 receives the control panel configuration data and imports the existing configuration data to control panel GUI 102, whereupon the customized or customizable printer control panels 100 may be reconfigured and saved in the manner previously described.

As previously discussed, stored customized or customizable printer control panels 100 may be automatically accessed from embedded Web server 54 upon initiation of a printing request from within a software application on a workstation 20 or a remote workstation 42. Additionally or alternatively, stored customized or customizable printer control panels 100 may be provided as stand-alone applications for accessing and managing the configuration of printing device 50, in which case customized or customizable printer control panels 100 may be accessed by identifying the proper URL for a Web page 56 associated with one or more of the customized or customizable printer control panels 100 by, for example, displaying links thereto. In this regard, the stored customized or customizable printer control panels 100 may be assigned their own URL and thus be individually accessible, or accessible as a “link,” through a Web page 56 displayable by embedded Web server 54. Other related or similar means for storing and accessing customized or customizable printer control panels 100 will be readily apparent to one of skill in the art, and are contemplated within the scope of the present invention.

It is recognized that certain customized or customizable printer control panels 100 which are remotely accessible, or which are accessible by a wide range of users over local network architecture 70, may contain specific functionalities for the operation of printing device 50 that should be restricted in use. For example, a particular customized or customizable printer control panel 100 may be configured with one or more functionalities relating to the access, manipulation and printing of items placed in a print job retention area of printing device 50 used for repetitive printing and permanent or semi-permanent storage. In such a case, preservation of the status quo within print job retention of printing device 50 may be important enough such that only a network administrator of local network architecture 70 (or other designated person(s)) should be permitted to change the settings thereof. Therefore, the storing of a particular customized or customizable printer control panel 100 may be associated with a password/PIN functionality such that retrieval of the particular customized printer control panel 100 may be effected only by authorized persons having knowledge of the password/PIN.

Customized or customizable printer control panels 100 that have been saved will preferably be displayed on control panel GUI 102 as labeled “control panel buttons” 118. A dialog box containing a “saved control panel identifier” associated with each control panel button 118 displays all or part of the file name under which the particular control was saved. For example, control panel button 118a is labeled, “Form Printing,” representing a customized printer control panel 100 with features pre-selected for the printing of commonly used forms; control panel button 118b is labeled “Economy Mode Printing,” representing a customized control panel 100 with features pre-selected for the printing of drafts or other printing needs involving, for example, draft quality paper, low print resolution, high speed printing, and the like; control panel button 118c is labeled “Newsletter Printing,” representing a customized control panel 100 with features pre-selected for the printing of newsletters; control panel button 118d is labeled “Default Control Panel,” representing a customized or customizable control panel 100 including one or more default features for generalized printing needs, or which may be used as a starting template to which features may be added or subtracted in forming a new, user-tailored, customized or customizable printer control panel 100; and control panel button 118e is labeled “Network Administrator Control Panel,” representing a customized control panel 100 with features pre-selected with the various needs of a network administrator in mind. By “pressing” or otherwise activating a control panel button 118, a previously configured and stored customized or customizable printer control panel 100 will appear as a control panel GUI 102 ready for use.

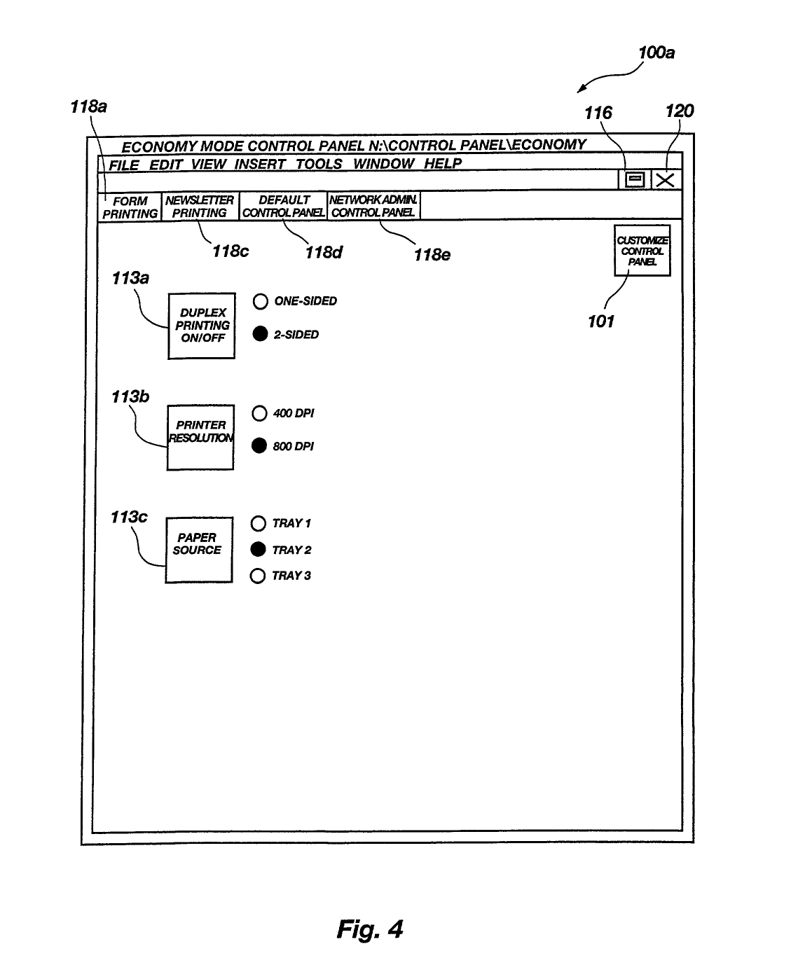

An example of an “Economy Mode Printing” control panel 100a for the operation of printing device 50 is shown in drawing FIG. 4. Economy Mode Printing control panel 100a includes selected labeled feature buttons 113 providing feature options such as duplex printing (duplex printing button 113a), selection of a print resolution (printer resolution button 113b), and selection of a paper source (paper source button 113c). These selected labeled feature buttons 113 have been previously selected from a feature library by a user in the manner described above, and are preset with various user-selected preferences. In the exemplary configuration in drawing FIG. 4, duplex printing button 113a is configured for 2-sided printing, printer resolution button 113b is shown preset to 400 dots per inch printing resolution, and paper source button 113c is set to paper tray 2 (e.g., where paper tray 2 is presumably a tray having a lower quality paper suitable for the printing of drafts). In the illustrated embodiment, a “customize control panel button” 101 is provided to permit further customization of Economy Mode Printing control panel 100a. Also shown are a save button 116 for saving a change to the existing configuration, a close button 120, and various control panel buttons 118 for calling up other saved customized or customizable print control panels 100.

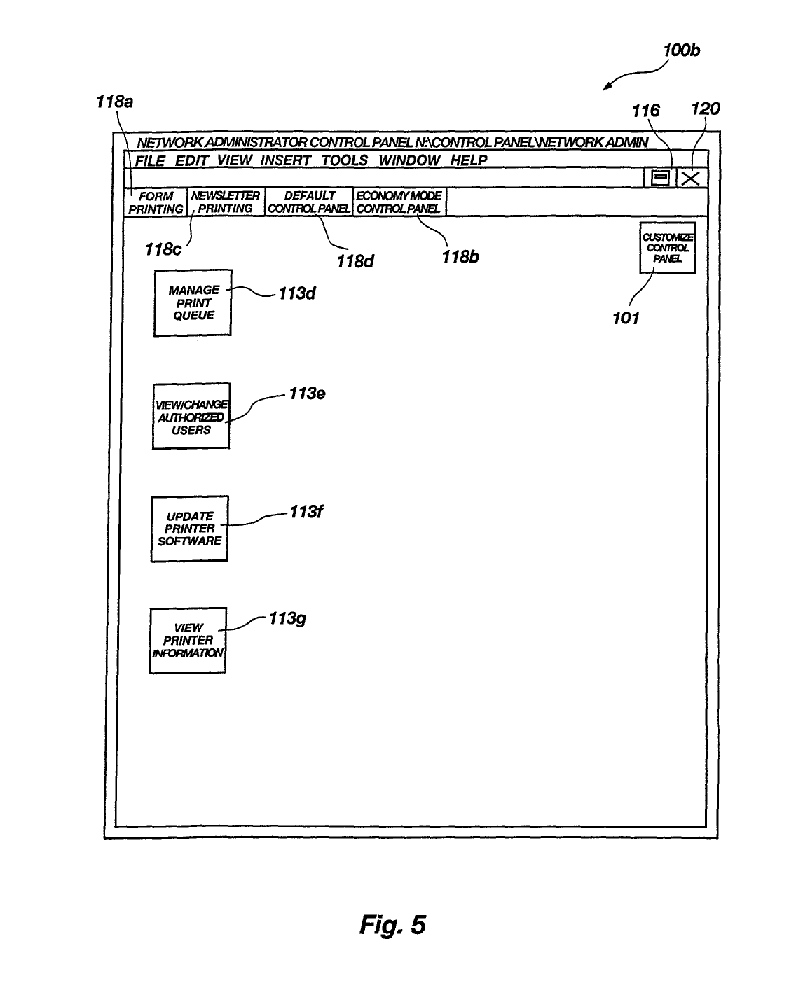

Illustrated in drawing FIG. 5 is a “Network Administrator Control Panel” 100b. Therein, selected labeled feature buttons 113 include “manage print queue” button 113d, “view/change authorized users” button 113e, “update printer software” button 113f, and “view printer information” button 113g. By selecting the various selected labeled feature buttons 113d-g, a Network Administrator or other authorized person is provided with the functionality represented by those buttons. For example, activation of “manage print queue” button 113d may allow the Network Administrator to set priorities for existing or future print jobs on printing device 50. Activation of “view/change authorized users” button 113e may provide various information and options pertaining to individuals authorized to use printing device 50. Typically, the user pressing “view/change authorized users” button 113e is thereafter provided with options and the corresponding capability to view existing authorized users of printing device 50, change existing access rights to printing device 50, and add new authorized users to printing device 50. By activating “update printer software” button 113f, Web server 54 of printing device 50 is triggered to poll a designated Web site for updates to resident software on printing device 50, and to download new software as needed. Web server 54 may be configured to automatically download the software, or may download the software manually in response to actions by the Network Administrator. In this regard, Web server 54 may display a Web page 56 having the software updates thereon and links thereto on Web browser 21 of the Network Administrator's workstation, thus allowing for manual selection of the desired software updates by the Network Administrator. When the “view printer information” button 113g is activated, the Network Administrator may be provided with data and options regarding printing device 50 specific information including, for example, diagnostics, usage records, printer status, and the like. Network Administrator Control Panel 100b also includes a customize control panel button 101 for further customization of Network Administrator Control Panel 100b, a save button 116, a close button 120, and various control panel buttons 118 configured to call up other saved customized or customizable print control panels 100.

According to another embodiment of the present invention, a “Network Administrator Control Panel” 100b may provide a Network Administrator with control panel options for initiating and/or configuring advertising banners, plug-in displays, and the like on one or more Web pages 56 displayable by embedded Web server 54 of printing device 50. In this regard, a third party may sell advertising displayable on portions of a Web page 56, with the Network Administrator installing, configuring, and/or overseeing the advertising displays through programming and/or software installation techniques well known in the art. In this embodiment, users surfing to Web server 54 are provided with one or more Web pages 56 displaying the subject advertising and plug-ins. Preferably, feature options related to the installation, configuration, and/or oversight of such advertising displays are provided as part of the library of selectable features for printing device 50 and embedded Web server 54. The Network Administrator may also be provided with utilities pertaining to the display of news, web-based email, or other information on a designated portion of one or more Web pages 56 of embedded Web server 54.

Referring back to drawing FIG. 3, control panel buttons 118 may be arranged in a tool bar-type fashion at, for example, a topmost, bottommost, or other location of customized or customizable printer control panel 100 which allows ease of viewing and selection of the control panel buttons 118. Alternatively, control panel buttons 118 may not be displayed initially, but may pop-up in a window upon activating, for example, a menu button (not shown) appropriately labeled and configured for retrieving stored control panels (e.g., a “retrieve stored control panels” button). Also in this regard, saved customized control panels 100 may be retrieved by clicking on, or otherwise activating, a file “open” button displayed on control panel GUI 102, and then selecting the designated file name for a specific previously stored customized or customizable printer control panel 100.

Thus, by selecting one of control panel buttons 118, the features previously selected for that particular labeled control panel file, as well as any saved manipulations of the arrangement and presentation of those control panel features, will be displayed on control panel GUI 102. A particular customized or customizable printer control panel 100 may thus be retrieved in the above-described manner, or according to other retrieval methods known in the art, for use in accessing, managing, and configuring printing device 50, or for further editing of the features of the customized or customizable printer control panel 100.

Referring again to drawing FIG. 2, a preferred method of interaction between printing device 50 and a workstation 20 or a workstation 42 is now described. As previously described, a user on a workstation 20 or a workstation 42 desiring to access or customize a customized or customizable printer control panel 100 submits a URL address associated with embedded Web server 54 to their respective Web browser 21. Using the URL, Web browser 21 sends a command in the form of a retrieval request to embedded Web server 54 over an appropriate communication link as identified in the URL address. The retrieval request is processed by microprocessor 60 of printing device 50, which causes embedded Web server 54 to transmit a Web page 56 to Web browser 21.

In an embodiment of the invention, Web page 56 contains an embedded <APPLET> tag associated with one or more interactive Java software applications or applets configured for accessing and configuring one or more customized or customizable printer control panels 100. Preferably, the <APPLET> tag references a source file for the one or more interactive Java applications stored in memory 62 of printing device 50. In accordance with a preferred embodiment of the present invention, hard disk 64 or ROM of printing device 50 contains at least one directory in memory 62, which stores the one or more interactive Java applications. The one or more interactive Java applications may also, or alternatively, be stored in a directory associated with separate memory dedicated to embedded Web server 54. The one or more interactive Java applications may comprise compressed or uncompressed files in memory 62 of printing device 60.

Preferably, a separate multi-threaded Java applet is provided for each major functionality represented by each of selected labeled feature buttons 113. In general, the Java applets, which may be controlled by a Java console, direct microprocessor 60 of embedded Web server 54 of printing device 50 to provide the user-selected printer configurations or other printing device 50 functionalities.

Web browser 21 downloads and displays the requested Web page 56, and requests the source file of the one or more interactive Java applications from embedded Web server 54 via the appropriate communication links.

Embedded Web server 54 processes the request, retrieves the one or more interactive Java applications from memory 62, and transmits the one or more interactive Java applications to Web browser 21, where they are downloaded, translated, and then executed by a Java Virtual Machine platform residing the requesting workstation (workstation 20 or remote workstation 42), or embedded within the Web browser 21 software. At a minimum, the Java Virtual Machine platform comprises at least a Java-enabled browser, a Java compiler to turn Java source code into Java byte code, and a Java interpreter to run Java programs. A Java console may also be provided on workstation 21 or remote workstation 42 to control the Java applets.

Upon downloading Web page 56 and executing the associated at least one interactive Java application, the at least one interactive Java application operates independently of Web page 56 to create, display and provide the functional capabilities of the interactive window of a customized or customizable printer control panel 100 in the manner previously described. After user-specific or network-specific configuration has been accomplished, the customized or customizable printer control panel 100 thus comprises a control panel GUI 102 selectively configured for assigning or changing the configuration and/or operational settings of printing device 50.

Upon closing a session with the one or more interactive Java applications, the downloaded Java applications and the resulting user-specific or network-specific configuration files may be stored to hard disk memory of the requesting workstation for later operational recall thereof. Alternatively, the resulting user-specific or network-specific configuration files may be stored in memory 62 of printing device 50, or in memory of some other network device (e.g., LAN server 74). In the latter two cases, the downloaded Java applications and configuration files are preferably automatically removed from RAM memory of the requesting workstation so as to free up resources for other applications.

The customizable control panel software of the present invention thus recognizes and interacts with computer and network operating systems to access, control, and/or manage a networked printing device. The customizable control panel software may also interact, directly or indirectly, with peripheral hardware and software, servers, and a wide variety of networked-based devices. In doing so, many advantages to prior art are apparent. For example, a user would have considerably more information and control over available peripherals. The customizable control panel software is customizable and thus provides the particular information and functionality the user desires. Also, the customizable control panel software function integrates multiple printing application functionality, which reduces complexity for the computer user. In addition, the Internet capability provided by the customizable control panel software significantly enhances its functionality. As an example, Internet HTTP addresses configured on a control panel for an embedded Web server of a printing device may facilitate ordering printing supplies, updating printing files, locating printer distributors, or other functions available via Internet.

In another embodiment of the invention, the customizable control panel software is used as a monitor and to change settings for networked printing devices, which are available to the computer. The customizable control panel software shows which printing devices are available, and the current jobs and/or status of each. Additionally, the customizable control panel software may allow changes to printer settings or job priority, depending on the level of access granted to the user.

In still a further embodiment of the invention, the customizable control panel software is configured to monitor printing device hardware, alerting a network administrator to hardware problems. In addition, customizable control panel software may be used to alert network personnel to printing software updates as well as technical updates or other administration specific information via the Internet. Usage statistics and utilization information may be monitored to facilitate printing device management.

In yet another embodiment of the invention, the customizable control panel software may be used to effectuate predetermined functions at user-determined times. For instance, it may be advantageous to schedule downloads of new print driver software or other peripheral software upgrades during so-called low use times. Thus, upgrades to software may be scheduled when higher bandwidth to the Internet is be available. In addition, these upgrades may occur automatically and without user intervention. Further, upgrades to the customizable control panel software may also be effectuated in this manner. Additionally, repetitive or large printing jobs may be scheduled by the user and executed by the customizable control panel software. Printing supplies may also be ordered on a schedule, upon designation of the user. The convenience and customizable functionality provided by the customizable control panel software greatly enhances the efficiency of the computer system and utilization of the peripheral.

It will be appreciated by those skilled in the art that the embodiments herein described while illustrating certain embodiments are not intended to so limit the invention or the scope of the appended claims. Those skilled in the art will also understand that various combinations or modifications of the preferred embodiments could be made without departing from the scope of the invention.

For example, it should be noted that features from the library of selectable features may be combined in any appreciable manner to create a customized control panel capable of performing any functionality pertaining to the configuration and operation of a printing device configured with an embedded Web server thereon. Furthermore, the customized control panels of the present invention may be configured to cause the subject workstation, the printing device and/or the embedded Web server thereon to affirmatively interact with other networked devices, such as print servers, to retrieve data, reconfigure or adjust settings, and the like. Thus, the customized control panels of the present invention preferably will be operative to provide a range of auxiliary functions which relate to the operation of the printing device, but which are not necessarily carried out by the printing device itself. Moreover, the methods of the present invention are applicable to other networked devices, such as fax machines, copiers, scanners, and the like.

Finally, while Java software applications have been specifically mentioned for use in the present invention, the functionality of the present invention may be implemented by various other programming languages, such as C++, PERL, Cobol, Smalltalk, C, and the like. Additionally, some or all of the software used in the present invention can reside on a networked server in byte-code form, which can be readily downloaded to and executed on any Java virtual machine.

Thus, while certain representative embodiments and details of the invention have been shown for purposes of illustrating the invention, it will be apparent to those skilled in the art that various changes in the invention disclosed herein may be made without departing from the scope of the invention, which is defined in the appended claims.

What is claimed is:

1. A method of customizing a printer control panel for a printing device incorporating a web server linked to a network comprising:
initiating a remote request over said network for a web page from said web server by a web browser, said web page associated with at least one software application, said at least one software application configured to provide customizable control panel functionality for controlling operations of said printing device;
transmitting said web page over said network;
downloading and displaying said web page using said web browser;
downloading said at least one software application using said web browser in response to downloading said web page, and
customizing a printer control panel using said at least one software application.

2. The method of claim 1, further comprising providing a library of selectable printing features by said at least one software application.

3. The method of claim 2, wherein said customizing comprises selecting at least one printing feature from said library of selectable printing features.

4. The method of claim 3, wherein each of said printing features of said library of selectable printing is associated with an identifier, and wherein said selecting comprises selecting said at least one printing feature on the basis of said identifier.

5. The method of claim 3, further comprising providing a workstation configured with said web browser.

6. The method of claim 3, further comprising storing said at least one printing feature.

7. The method of claim 6, wherein said storing comprises storing said at least one printing feature in a memory component of said printing device or said workstation.

8. The method of claim 7, wherein said customizing comprises customizing a previously stored printer control panel, said previously stored printer control panel accessed from said memory component of said printing device or said workstation.

9. The method of claim 8, further comprising accessing said previously stored printer control panel using at least one of a PIN or a password.

10. The method of claim 6, further comprising arranging said at least one printing feature in a user-determined configuration prior to said storing.

11. The method of claim 3, further comprising arranging said at least one printing feature on a graphical user interface displayed within said web browser.

12. The method of claim 3, wherein said web browser comprises a java-enabled web browser.

13. The method of claim 12, further comprising executing said at least software application using a Java Virtual Machine platform on said workstation

14. The method of claim 1, wherein said initiating said remote request over said network comprises initiating said remote request over the Internet.

15. A system for customizing a printer control panel, comprising:
a printing device incorporating a web server, said web server linked to a network,
at least one workstation configured for communicating with said network, said at least one workstation having a web browser thereon; and
at least one software application transmissible by said web server and accessible by said web browser, said at least one software application configured to provide customizable control panel functionality for said printing device through user input on said at least one workstation.

16. The system of claim 15, further comprising a Java Virtual Machine and a Java console accessible by said at least one workstation.

17. The system of claim 15, wherein said at least one software application is configured to display a library of selectable printing features within a window displayable on a display of said workstation.

18. The system of claim 17, wherein said library of selectable printing features comprises the complete array of control features for the operation of said printing device.

19. The system of claim 15, wherein said at least one software application comprises a plurality of separate multi-threaded Java applets, and wherein each of said separate multithreaded Java applets is configured to control at least one operative functionality of said printing device.

20. A method of configuring a customized printer control panel configured for printer functionality for a printing device incorporating a web server linked to a network using a workstation communicating with said network, said workstation having a java-enabled web browser and a Java Virtual Machine platform, said method comprising:
initiating a request over said network for a web page from said web server using said java-enabled web browser, said request initiated by specifying a network address of said web page to said java-enabled web browser, said web page having at least one applet tag referencing at least one applet responsive to said request;
transmitting said web page over said network to said java-enabled web browser;
downloading and displaying said web page using said java-enabled web browser;
downloading said at least one applet using said java-enabled web browser in response to downloading said web page, said at least one applet programmed to provide customizable control panel functionality for controlling operations of said printing device;
executing said at least one applet using said Java Virtual Machine platform;
customizing said printer control panel using said at least one applet operating within said web browser; and
storing said printer control panel in a memory component of said printing device or said workstation.
